(19) United States
(12) Patent Application Publication
(10) Pub. No.: US 2011/0183057 A1
(43) Pub. Date: Jul. 28, 2011

(54) FOAMING DEVICE AND METHOD OF PROVIDING FOAMED PRODUCT

(75) Inventors: Stuart Michael Ruan Jones, Royston (GB); Mark Robson Humphries, Saffron Walden (GB); David Morrison Russell, London (GB)

(73) Assignee: PA KNOWLEDGE LIMITED, London (GB)

(21) Appl. No.: 12/933,371

(22) PCT Filed: Mar. 19, 2009
(86) PCT No.: PCT/GB2009/000740

§ 371 Date: Feb. 24, 2011

(30) Foreign Application Priority Data
Mar. 20, 2008 (GB) 0805291.2

(51) Int. Cl. B65D 85/73; A47J 31/44; B01F 3/04

(52) U.S. Cl. 426/474; 99/516; 99/484

(57) ABSTRACT

A foaming device for a drink including a housing defining an internal volume for housing secondary liquid and a source of foaming gas. A nozzle communicates between the internal volume and an exterior of the housing and a plug seals the nozzle so as to prevent communication between the internal volume and the exterior of the housing. By releasing the plug, the secondary liquid can be released into the drink such that the foaming gas forms bubbles of secondary liquid in the drink and proteins/constituents within one or both of the primary liquid and the secondary liquid denature so as to create a stable foam.

The present invention relates to a foaming device for a drink, in particular which can be provided in a dispensable/disposable drinks cup, and also to a method of providing a foamed product, for example a foamed milk or dairy product in a drink.

Conventionally, when making a hot coffee drink in the style of “cappuccino”, semi-skimmed milk is processed by passing hot steam through cold milk at a prescribed rate so as to entrain air into the milk and make a stable foam. This method requires a machine and is very much dependent on the operator's skill and familiarity.

Drinks products also exist for coffee which reproduce the foam by adding a surfactant to avoid the need for controlling the denaturing process. However, unfortunately, this does affect the overall taste and quality of the resulting foamed product.

The present invention is based at least partly on the recognition that, when releasing a bubbled secondary liquid into a primary liquid, the secondary liquid can be denatured so as to produce stable bubbles and, where the secondary liquid is hot, the primary liquid can be denatured. For instance, by releasing milk bubbles into a hot drinks liquid, such as coffee, milk constituents in the walls of the bubbles denature so as to create a surfactant that will hold a stable foam on the surface of the coffee giving an effect like that in a traditional “cappuccino” coffee.

It has been known previously to release gases, such as carbon dioxide, from pressurised containers into cold drinks, such as beer, to create a foam on that drink. However, only gas is released into the liquid of the drink such that it is the liquid of the drink itself that is foamed. There has been no consideration given to foaming and stabilising a secondary liquid as it is released into the primary drinks liquid. Indeed, use of gases such as carbon dioxide for a secondary liquid such as milk would actually cause curdling.

According to the present invention, there is provided a method of providing a foamed secondary liquid in a drink, the method including: providing the secondary liquid with a foaming gas under pressure and releasing the secondary liquid and foaming gas into a primary liquid such that the drink is formed and bubbles of secondary liquid are formed in the primary liquid.

Preferably, proteins/constituents within one or both of the primary liquid and the secondary liquid denature so as to create a suitable surfactant/surface structure to hold a stable foam.

In this way, it is possible to form a stable foam of secondary liquid in or on a primary liquid.

Although the secondary liquid could be chosen to be the same as the primary liquid, in many embodiments, a foam of a different liquid can easily be provided in or on the primary liquid. When provided in the primary liquid, this may be used to texture the drink, and or create a head.

In one embodiment, the secondary liquid may be provided under pressure with the foaming gas dissolved therein. Upon releasing the secondary liquid into the primary liquid, the foaming gas comes out of solution.

This provides a simple and convenient way of storing and releasing both the foaming gas and the secondary liquid.

The primary liquid may be heated. In this case, when the secondary liquid is released into the hot primary liquid, proteins in the secondary liquid are denatured by the heat of the primary liquid. Hence, a stable foam is automatically formed by virtue of the heat of the primary liquid.

Alternatively or additionally, the nozzle may be configured to cause shear of the secondary liquid thereby to denature constituents in the secondary liquid. With this arrangement, it is not necessary for the primary liquid to be heated.

Alternatively or additionally the configuration of the nozzle may also act to control the temperature, flow rate, initial secondary liquid droplet size and the resultant bubble size within the foam and by nature of this control improve the foam stability.

In a preferred embodiment, a milk product is provided as the secondary liquid.

According to the present invention there is also provided a foaming device. The foaming device may be provided with a housing defining an internal volume for housing a secondary liquid and a source of foaming gas and defining a nozzle communicating between the internal volume and an exterior of the housing. It may also be provided with a plug for sealing the nozzle so as to prevent communication between the internal volume and the exterior of the housing, the plug being selectively openable to allow communication between the internal volume and the exterior of the housing.

The internal volume may be configured to house foaming gas under pressure.

The secondary liquid may contain the foaming gas dissolved therein and, hence, the housing may be configured to house under pressure the secondary liquid containing the foaming gas dissolved therein.

In an alternative arrangement, the internal volume may include a first volume for housing the foaming gas and a second volume for housing the secondary liquid.

With this arrangement, when the device is activated, the foaming gas may be released into the secondary liquid so as to saturate or partially saturate the secondary liquid and drive the secondary liquid into the primary liquid as bubbles of the secondary liquid.

Rather than store the foaming gas either by itself or dissolved in the secondary liquid, it is also possible to produce the foaming gas by reaction. In this case, the source of foaming gas may be at least one compound able to produce foaming gas by reaction, examples of effervescent couples include calcium carbonate, magnesium carbonate or sodium bicarbonate with an appropriate acid including ascorbic, citric or tartaric acid, or water.

In one example the housing could provide separate chambers for the base salt and the acid having a rupturable divide, that when activated allows the reaction elements to mix and the foaming gas to be produced and in turn rupture a secondary divide and be released into the secondary liquid so as to saturate or partially saturate the secondary liquid and drive the secondary liquid into the primary liquid as bubbles of the secondary liquid.

In another example the base salt and the stabilised acid i.e. stabilised through the use of encapsulation techniques, could be stored together and the reaction initiated by the secondary liquid when the divide between the chamber containing the effervescent couple and the chamber containing the secondary liquid is ruptured. Preferably, the housing defines at least one chamber respectively for said at least one compound. A rupturable divide may be provided between the at least one chamber and the internal volume.

Where the at least one compound is able to provide the foaming gas without contact with the secondary liquid, the rupturable divide may be configured to rupture so as to release that foaming gas into the secondary liquid. In this example, for instance, two compounds may be provided which, when mixed, provide the foaming gas.

It is also possible for the rupturable divide to be configured to be ruptured so as to allow the secondary liquid to mix with the at least one compound. In this example, mixing of the secondary liquid with the compound may itself cause production of the foaming gas in the secondary liquid.

Thus, in the example of a milk product as the secondary liquid, with the foaming device located at the bottom of a drinks cup, when the plug is opened or breached so as to allow communication between the internal volume and the exterior of the housing, the pressure of the foaming gas will cause the liquid milk product to pass from the internal volume of the housing to the exterior of the housing. Upon reaching the lower pressure of the drinks liquid, the foaming gas forms bubbles in the milk product. As the milk bubbles pass upward through the hot drinks liquid, the milk proteins denature creating a stable foam on the surface of the drink. Any milk product that has not denatured and not formed foam will mix with the drink. Preferably in this embodiment, the plug is activated by heat, in other words communication is allowed according to temperature. The present invention allows the advantage that, at a predetermined activation temperature, the process of gas release and subsequent denaturing is controlled and provides a consistent result. In addition, activation of the device will give a signal to the user that the drink is ready (for instance is at the right temperature) for consumption.

It is also possible to provide a housing with a supplementary internal volume for housing a tertiary component for release into the primary liquid.

The tertiary component may comprise a powder for use as part of the drink.

The supplementary internal volume may be configured to provide a communicable path between the nozzle and the internal volume. It may be separated from the internal volume by a rupturable seal and may house the tertiary powder. Upon activation of the device, the seal ruptures and secondary liquid from the internal volume flows through the supplementary internal volume and carries tertiary powder out of the nozzle.

Of course, the mechanism for producing the foaming gas and driving the secondary liquid can be any of those discussed above.

The tertiary powder may be at least partly soluble by the secondary liquid flowing through the supplementary internal volume. Alternatively or additionally, the tertiary powder may have relatively low solubility and therefore be suitable for forming nucleation sites upon which the bubbles may form and or forming a well dispersed suspension within the body or foamed head of the primary liquid

It is also possible to provide a tertiary liquid as the tertiary component. This may be released together with or separately from the secondary liquid. Also, the timing of its release may be chosen to be before, after or overlapping with release of the secondary liquid.

The housing may define a supplementary nozzle communicating between the supplementary internal volume and the exterior of the housing and a supplementary plug for sealing the supplementary nozzle so as to prevent communication between the supplementary internal volume and the exterior of the housing. The supplementary plug may be selectively openable to allow communication between the supplementary internal volume and the exterior of the housing. If for example the plug and supplementary plug are thermally activated then the plugs could be tuned to open at the same or different temperature.

It is possible for the supplementary plug to be provided integrally with the plug such that they both open their respective nozzles together.

The plug can be user activatable to open the nozzle and release the secondary liquid from the housing. The user activation can be achieved by direct user intervention in operating a part of the device or as a result of applying heat to the device, and by way of example microwave energy to the device. All of these arrangements allow a user to create the foamed product as and when required.

The plug may be at least partly constructed from a material which, at temperatures above a predetermined temperature, opens the nozzle.

In this way, it is possible merely for the user to heat the drinks liquid in which the device is located or to bring a hot drinks liquid and the device together. As an appropriate temperature, for instance above 35° C. and more preferably, perhaps 70° C., the plug opens, ruptures etc. to allow the foaming process to take place.

The plug could be formed from edible wax, such as rice-bran wax, a polymer film, a bi-metallic component or a shape memory polymer.

Similar approaches for controlling the communication and rupture of the divide between chambers within the housing could also be considered, with the temperature of rupture (opening) being tuned to the specific requirements of the product though component design and plug material selection

The plug may be at least partly constructed from a material which, at temperatures above a predetermined temperature opens the nozzle as a result of increased pressure within the internal volume.

In this way, when the device is heated, for instance by microwave, and the pressure within the device increases, at some predetermined temperature/pressure, the plug can be arranged to open or rupture so as to break the seal and allow communication between the internal volume and the exterior of the housing.

It is also possible for the plug to be float activated. A float valve or ball cock can be provided for operating the plug. The primary liquid of the drink, for instance coffee or water, is poured over the foaming device and the float valve rises according to its buoyancy and operates the plug to break its seal.

It is also possible to provide a plug with an activation mechanism making use of hydration. In other words, the plug somehow responds to the presence of water to open and unseal the nozzle. Examples of this include the use of soluble plugs, for instance constructed from sugar, plugs constructed from shape memory polymers (eg polyurethane SMP) which change in shape in response to contact with water, or volume expansion through water absorption.

Hence, plugs could be used which include at least one of an edible wax, a polymer film, a bi-metallic component, a shape memory polymer and a microwave activated component.

The size and shape of the nozzle can be used in conjunction with internal pressure to control velocity and bubble size. It is also possible to use a variety of different shapes of nozzle opening. However, the open cross-sectional area of the nozzle is preferably equivalent to a diameter in the range of 0.01 mm to 3 mm. More preferably, the diameter is in the range of 0.05 mm to 0.5 mm, for instance approximately 0.3 mm.

The nozzle may be configured to cause shear of the secondary liquid thereby to denature proteins in the secondary liquid for this multiple smaller orifice sizes, for instance each approximately 0.1 mm may be preferred. This is particularly advantageous for use with cold drinks in producing a stable foam.

Thus, by selecting appropriate nozzle design and orifice size it is possible for the nozzle to be configured to produce bubbles in suspension in the primary liquid so as to texture the drink.

The foam produced according to another aspect of the invention may have bubbles of a size that, in effect, form a suspension in the primary liquid and, thereby, texture the drink.

Preferably, the nozzle is located towards the base or low on one side of the device such that it promotes ejection of the secondary liquid in preference to releasing only foaming gas; the foaming gas will form in the upper space or head space within the internal volume of the housing.

In one embodiment, the nozzle may be angled so as to direct a jet of secondary liquid and bubbles in a predefined direction. Directing the nozzle in a direction tangential to the main circumference of the cup will induce circulation (or swirl) of the fluid, assisting mixing of any additive components such as sugar.

Directing the nozzle vertically upwards through the primary liquid will reduce the time that a bubble is passing through the liquid (the transition time), which is critical to tuning the stability of the foam.

The optimum direction of the nozzle is determined by obtaining the desired residence time and inducing the required degree of circulation (or swirl). The nozzle would ideally be pointed in any combination of these two directions, and since they are orthogonal any direction between horizontal and vertical is acceptable.

The internal volume of the device will depend upon the drinks cup and volume of drinks liquid with which the device is intended to be used.

It is proposed to provide internal volumes between 0.5 ml and 100 ml. More preferably, volumes may be provided between 1 ml and 50 ml and, more preferably still, between 10 ml and 25 ml. For a disposable coffee cup of 300 ml volume, an internal volume of approximately 15 ml might be appropriate for the device.

As supplied, in one embodiment, the housing preferably houses under pressure a liquid milk product containing a dissolved foaming gas.

The milk product may be natural or artificial milk or cream separately or in combination and may include additional flavourings, etc. In particular, milk products include milk, artificial milk substitute, milk with flavourings, sweeteners and traditional coffee additives such as vanilla and caramel syrups or alcoholic beverages like whiskey, or whisky

In this embodiment the foaming gas is preferably not carbon dioxide.

The foaming gas is preferably one of nitrous oxide, nitrogen, helium or any other inert gas.

The pressure provided initially within the device can be chosen in conjunction with the internal volume and the nozzle size to vary the characteristics of the bubbles. The pressure should be greater than atmospheric pressure at the exterior of the housing and, hence, be greater than 1 bar.

Preferably, pressures between 2 bar and 15 bar are used. More preferably, pressures between 8 bar and 12 bar are used, such as approximately 10 bar. In other applications, pressures between 4 bar and 8 bar may be more appropriate.

According to the present invention there may be provided a disposable drinks cup having a foaming device as defined above fitted to the bottom internal surface of the cup.

The cup may come pre-filled with a dried drinks product for mixing with water or may come pre-filled with a liquid drinks product for heating.

The present invention will be more clearly understood from the following description, given by way of example only, with reference to the accompanying drawings, in which:

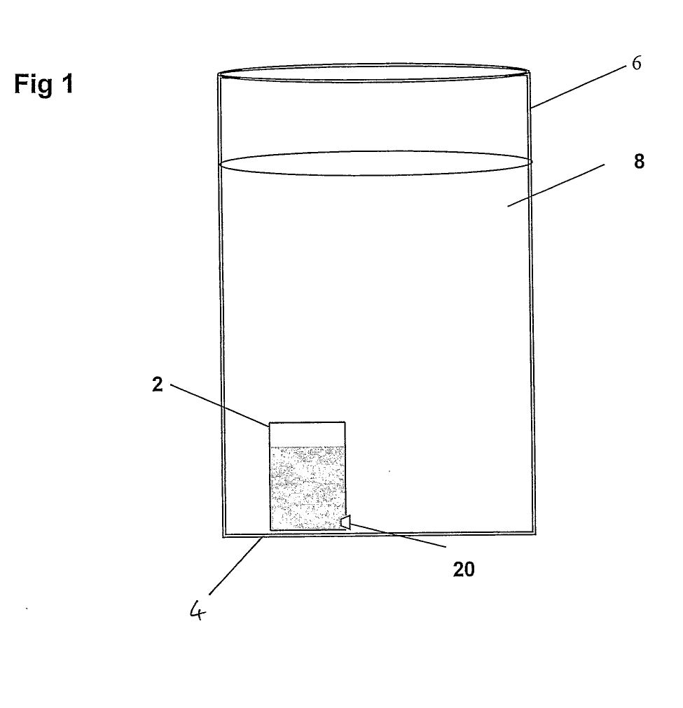

FIG. 1 illustrates schematically a cup containing a device according to the present invention;

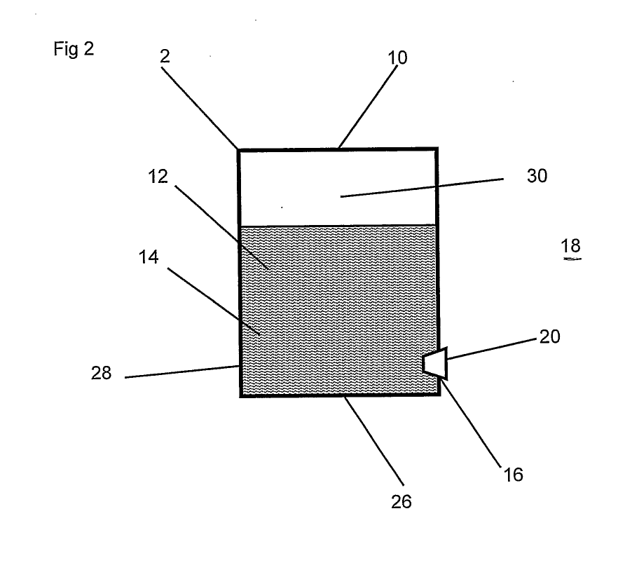

FIG. 2 illustrates schematically the device of FIG. 1;

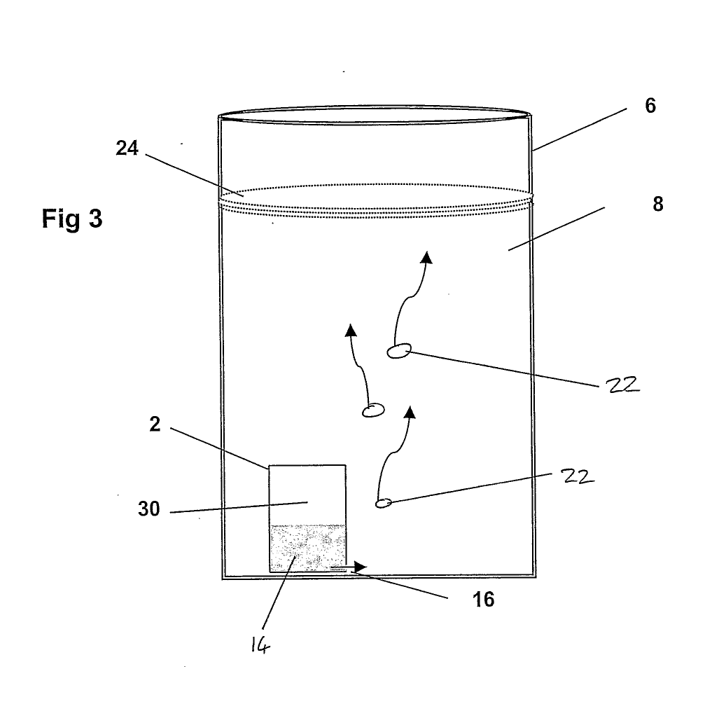

FIG. 3 illustrates schematically release of milk product from the device of FIG. 1;

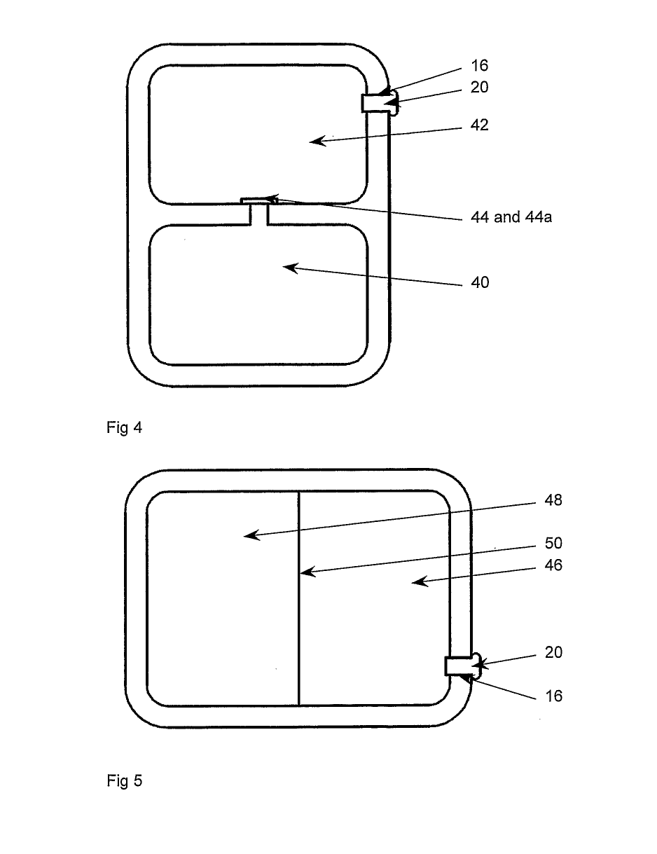

FIG. 4 illustrates schematically a device having a first volume for housing foaming gas and a second volume for housing secondary liquid;

FIG. 5 illustrates schematically a device having a chamber for housing a compound as a source of foaming gas;

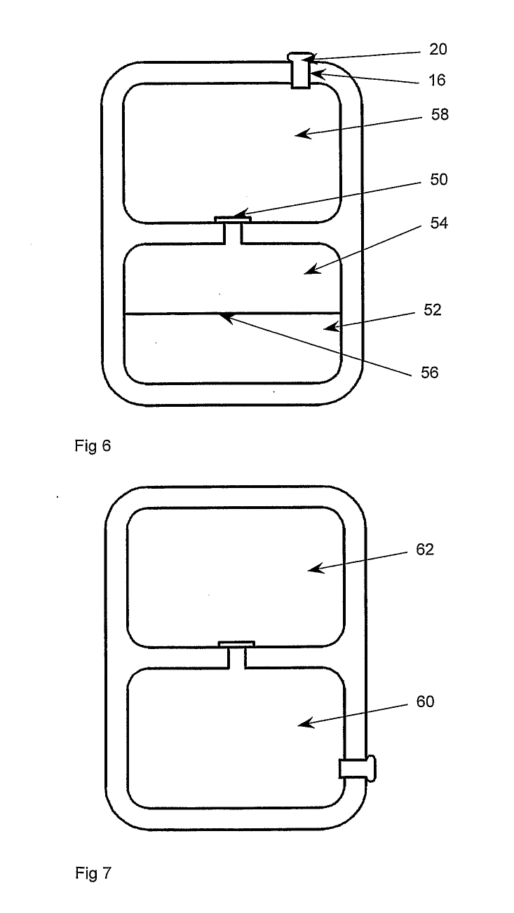

FIG. 6 illustrates schematically a device including two chambers for holding respective compounds for together producing a foaming gas;

FIG. 7 illustrates schematically a device including a supplementary internal volume for holding a tertiary liquid;

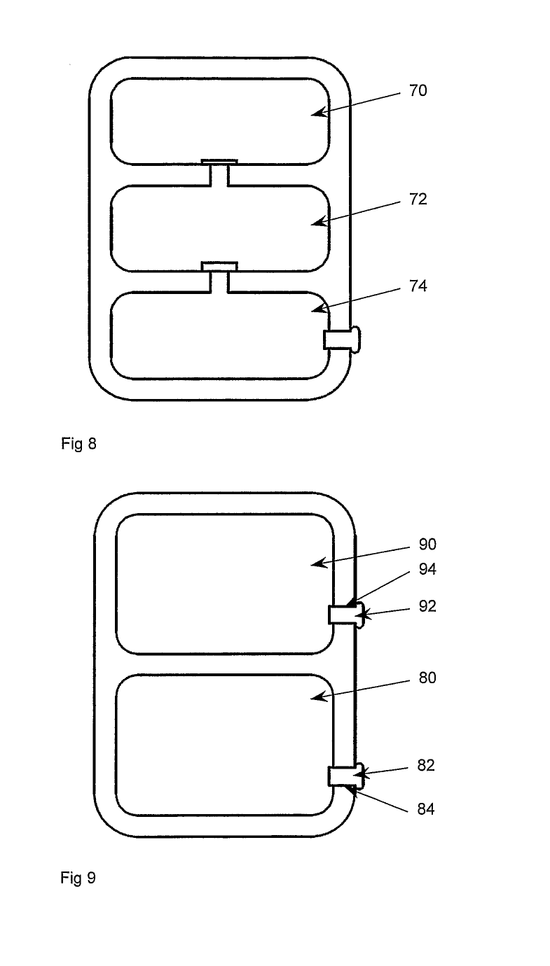

FIG. 8 illustrates schematically a device including a separate volume for foaming gas and a supplementary internal volume for a tertiary liquid;

FIG. 9 illustrates schematically a device including two internal volumes;

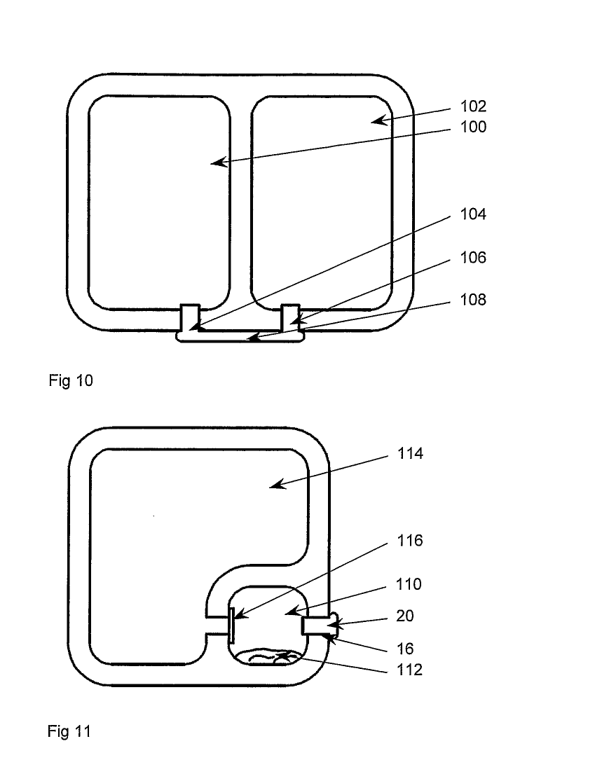

FIG. 10 illustrates schematically a device including two internal volumes with a common integral plug;

FIG. 11 illustrates schematically a device including a supplementary internal volume for containing a tertiary powder; and

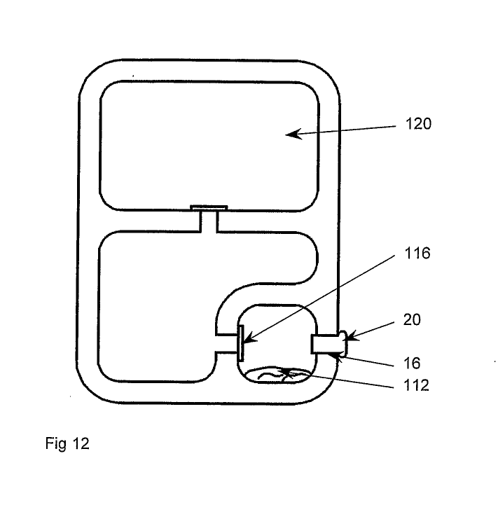

FIG. 12 illustrates schematically a device having a supplementary internal volume for containing a tertiary powder, together with foaming gas stored in a separate volume.

The following preferred embodiment relates to a device of the present invention located at the bottom of a cup, such as a disposable coffee cup, for providing a foamed milk product.

FIG. 1 illustrates schematically a device 2 fitted at the bottom 4 of a cup 6 containing a drinks liquid 8, such as coffee.

FIG. 2 illustrates schematically a device 2 on its own.

The device 2 includes a housing 10 which defines an internal volume 12 filled with a pressurised milk product 14 having dissolved in it a foaming gas, such as nitrous oxide and a head space 30.

A nozzle 16 provides communication between the internal volume 12 and the surroundings 18 of the device 2. A plug 20 seals the nozzle 16.

As illustrated in FIG. 3, when the plug 20 is opened, ruptured, breached etc. such that the nozzle 16 provides communication between the internal volume 12 of the device 2 and the drinks liquid 8 in the cup 6, the milk product is driven, by the pressure within the internal volume 12, out into the drinks liquid 8.

As the milk product 14 is released from the device 2, the foaming gas, for instance nitrous oxide, comes out of solution and causes bubbles 22 to form in the milk product within the drinks liquid 8. As the milk product bubbles 22 pass upward through the hot drinks liquid 8, milk proteins denatures creating a stable foam 24 on the surface of the drinks liquid. Milk product that has not denatured and not formed foam will mix with the drinks liquid 8.

In the illustrated embodiment, the device 2 has a base 26 with side walls 28 extending upwardly therefrom. The nozzle is formed preferably at least proximate to the base 26. In this way, as the foaming gas comes out of solution from the milk product 14 still held within the device 2, it rises up within the device 2 to form an expanding head space 30 which continues to drive the milk product 14 out of the nozzle 16.

In a preferred embodiment, the nozzle 16 is angled so as to direct a jet of the milk product and bubbles 22 upwardly.

In one example of the present invention, 15 ml of milk saturated with nitrous oxide at 10 bar pressure is contained within a cylindrical device 2 at the bottom of a disposable coffee cup 6 of 300 ml volume. The nozzle preferably has an opening of approximately 0.2 mm diameter towards its base 26 which is sealed using a plug made of an edible rice-bran wax with a melting temperature of between 70 and 77° C., and preferably approximately 72° C.

In one preferred embodiment, the device 2 may be provided with a metal layer to shield its contents from microwave heating. It may additionally or alternatively incorporate a thermal insulation layer between the device and its surroundings, for instance the coffee 8 in the cup 6.

The coffee 8 in the cup 6 can be heated, for instance in a microwave. When the temperature of the coffee reaches 72° C., the wax plug will melt and the milk product will be released to form the foam as described above.

It will be appreciated that other forms of plug 20 can also be used. These include:

polymer film (for activation directly in response to temperature or activation in response to elevated pressures resulting from elevated temperatures.)

user activated

float activated, eg a float which rises in the liquid surrounding the device

bi-metal temperature/shape memory polymer

hydration, eg a soluble plug or a shape memory polymer responsive to the presence of water

microwave activated strip or conductive metal film that assist in focussing heat where required to deliver the required thermal response.

Although carbon dioxide is not suitable for use with a milk product, other gases in addition to nitrous oxide might be used, for instance nitrogen, helium or other inert gases.

Generally, it is considered that an ideal drinking temperature for hot beverages may be between 60 and 80° C. However, denaturing of milk protein should occur above approximately 35° C. Hence, releasing the milk product at or around the desired drinking temperature will give the desired effect.

Other embodiments include adding a hot beverage to a disposable cup already containing the device. Alternatively, the device can be added to any standard cup/mug or bowl before or after adding the hot beverage.

The present invention is of course not limited only to coffee and could be used in other drinks/beverages using foamed milk products, such as hot chocolate.

It would also be possible to pre-fill the internal volume of the housing of the device with a liquid other than a milk product but still containing a gas under pressure. The device could then be used to deliver that secondary liquid (for instance as a flavour or as a colour) and assist in the mixing of that secondary liquid with the primary liquid in the cup. For instance, this could be used with a fruit drink (such as a blackcurrant drink), medicating drinks, liqueur coffees, soft drinks etc.

Thus, it is also possible to provide thermal release of pressurised secondary liquids into a primary liquid system at an elevated temperature.

In the preferred embodiment described above, it was mentioned that microwave shielding could be provided around the device and that a thermal barrier could be provided. Certainly, it is desirable in some embodiments to limit the heating of the milk product in the device whilst heating the liquid in the cup. Of course, the drinks liquid could be heated separately or the system could be activated by the pouring in of hot or boiling water or other liquid forming part of the drink

The actual denaturing process will be influenced by a number of factors including; the temperature of the primary and secondary liquids, the constitution of the secondary liquid, the size of bubble released through the nozzle and the transition time. In particular, energy transfer will cause material change on heating. This can be controlled by adjusting the factors identified above

The transition time for the milk product can be controlled according to the velocity from the device, the pressure in the device, the nozzle size, the resulting bubble size, viscosity and cup dimensions. The cup dimension (or path length) can be considered as the total distance that a bubble has to travel within the fluid.

The bubble solidification is governed by the amount of energy transferred to the bubble wall. At a particular temperature the total energy transfer is proportional to the time that the bubble is exposed to the heated fluid. The time that the bubble is exposed to the heated fluid is proportional to the distance that the bubble has to travel (the path length) and the speed that the bubble travels at. In turn, the speed of the bubble is (for small bubbles at least) related to the radius of the bubble, the viscosity of the fluid, the density of the fluid, the density of the foaming gas and the force acting upon the system due to gravity. The bubble radius is affected by the speed of ejection from the nozzle, the shape and size of the nozzle, the volume of gas in the bubble, and the surface energy at the liquid-gas interface.

The conductivity and transition temperature will also have an influence. The temperature of the drinks liquid upon release of the milk product will have an influence, as will the nature of any turbulence in the flow of the milk product. Of course, the actual nature of the milk product, for instance its chemical make-up will have an influence. Also, additives such as surfactants/foam stabilisers and proteins will influence the resulting foam.

When designing a device for a particular application, all of these factors can be taken into account to produce the desired foam.

Although a particular embodiment has been described with reference to use of a milk product as a secondary liquid and use of the foaming gas dissolved in that secondary liquid, other embodiments are possible using different secondary liquids and providing a different source of foaming gas within the foaming device.

In the embodiment of FIG. 4, the internal volume is divided into a first volume 40 for housing the foaming gas and a second volume 42 for housing the secondary liquid. In other words, the foaming gas is not dissolved in the secondary liquid, but is stored separately. A light membrane 44 may be provided separating the first volume 40 to the second volume 42 such that when the plug 20 opens the nozzle 16, the membrane ruptures and the pressurised foaming gas passes up through the secondary liquid 42 and out through the nozzle 16 so as to form bubbles in the primary liquid of the drink.

In another embodiment, the membrane 44 could be replaced by a heat activated plug 44a tuned to open at a lower temperature that the plug 20 such that on heating the plug 44a opens and allows the pressurised gas within the first volume 40 to enter into the second volume 42 and dissolve into the secondary liquid shortly before the opening of plug 20 and the release of the secondary liquid containing the dissolved gas through the nozzle.

It is also possible that the foaming gas is provided from an alternative source which might be liquid or solid.

In the embodiment of FIG. 5, a chamber 46 is provided for communication with the internal volume 48. A ruptural divide 50 separates the chamber 46 from the internal volume 48.

Any appropriate means may be provided for rupturing the divide 50 and allowing the secondary liquid of the internal volume 48 to mix with the contents of the chamber 46. For instance, a user may squeeze and mechanically deform the housing.

The chamber 46 may be provided with any suitable liquid or solid compound for producing the foaming gas. For instance, the chamber 46 may contain bicarbonate of soda such that when a water based secondary liquid in the internal volume 48 mixes with it, foaming gas is produced. In this embodiment, it may be that, with time, sufficient pressure will naturally build up to breach the plug 20 of the nozzle 16. The time taken for this may easily be sufficient for a user first to cause rupturing of the divide 50, for instance by squeezing the device, and then dropping the device into a cup.

An alternative embodiment may be one in which chamber 6 contains one or more of a number of alkali salts such as calcium carbonate, magnesium carbonate or sodium bicarbonate with an appropriate stabilised acid for example encapsulated ascorbic, citric or tartaric acid. In this situation, the dissolution of the encapsulate by the secondary liquid will initiate an acid base reaction initiating CO2 gas that will provide the internal pressure required for the functionality of the concept. In this way the CO2 gas can be kept separate from the secondary liquid during extended shelf life and storage, minimising risks of flavour taint and or secondary liquid spoilage.

FIG. 6 illustrates a variation to this arrangement where two chambers 52, 54 are provided containing respective compounds which together produce the foaming gas. In this arrangement, the divide 56 between the first and second chambers 52, 54 may be ruptured, for instance by squeezing the device, to cause mixing of the compounds in the first and second chambers 52, 54 and production of the foaming gas. On the other hand, the divide 50 connecting the first and second chambers to the internal volume 58 may remain intact until the plug 20 of the nozzle 16 is breached. Of course, this embodiment becomes similar to the embodiment of FIG. 4. With opening of the plug 20 in the nozzle 16, the foaming gas produced by the first and second chambers 52, 54 will rupture the divide 50 and pass out of the nozzle 16 with the secondary liquid to produce the desired bubbles.

FIG. 7 illustrates an embodiment using a supplemental internal volume 60 in combination with an internal volume 62 similar to that described with reference to FIG. 2. The supplementary internal volume 60 can be used to house a tertiary component for release into the primary liquid.

As will be discussed further below, the tertiary component can be either liquid or solid and can be released together with or separately from the secondary liquid.

In the embodiment of FIG. 7, although the tertiary component is stored within the device separately in the supplementary internal volume, upon actuation of the device, the tertiary compound is driven out by and with the secondary liquid. This arrangement may be useful when it is desirable to keep the secondary liquid and tertiary component separate during storage.

FIG. 8 illustrates a variation to the embodiment of FIG. 7 incorporating features of the embodiment of FIG. 4 whereby the internal volume is divided into a first volume 70 for foaming gas and a second volume 72 for the secondary liquid. These are provided in conjunction with a supplementary internal volume 74 for a tertiary component.

FIG. 9 illustrates an embodiment in which the supplementary internal volume 90 is provided quite separately from the internal volume 80. As illustrated, the supplementary internal volume is provided with its own plug 92 and nozzle 94 quite separate from the plug 82 and nozzle 84 of the main internal volume 80. The plugs 82 and 92 may be configured to open in sequence or in an overlapping manner. Although the supplementary internal volume 90 could also provide a foamed tertiary component, the tertiary component may merely be an unfoamed liquid. Thus, in the example of providing foamed milk with coffee, the supplementary internal volume 90 could merely contain a syrup.

FIG. 10 illustrates a cross-section in plan view of a lower portion of an alternative embodiment having both an internal volume 100 and a supplementary internal volume 102. In this embodiment, the plug 104 and supplementary plug 106 are provided integrally as part of a common plug 108 which opens the two volumes together or in a predetermined sequence.

In the embodiment of FIG. 11, the supplementary internal volume 110 is provided for containing a tertiary powder 112. As illustrated, the supplementary internal volume 110 provides a communicable path between the nozzle 16 and the internal volume 114. A rupturable seal separates the supplementary internal volume 110 from the internal volume 114 and contains the tertiary powder. Upon activation, the second liquid passes through the supplementary internal volume and carries with it the tertiary powder out of the nozzle 16 into the surrounding primary liquid. The tertiary powder may be partly or entirely soluble and, indeed, may dissolve prior to passing through the nozzle 16.

In another embodiment, the tertiary powder can be used to provide nucleation sites upon which bubbles may form. And in yet another embodiment the tertiary powder may be non dissolvable and form a suspension in the primary liquid and utilise the flow of the secondary liquid, with its dissolved gas, to provide improved distribution and particle break-up

FIG. 12 illustrates a variation of the embodiment of FIG. 11 using foamed gas stored in a volume 120 separate from the internal volume 114. It will be appreciated that other variations are possible, for instance combining features from the other embodiments described above.

In the embodiments described above, reference has been made to denaturing proteins of the secondary liquid by heating the secondary liquid from the primary liquid. However, it should be appreciated that it is also possible to denature the secondary liquid using a process of sheer. In this respect, denaturing can be achieved by appropriately sizing and shaping the outlet nozzle of the device. This is particularly useful for producing foams in drinks which are not hot.

By appropriately sizing the nozzles, it is also possible to produce bubbles which are sufficiently small that they, in effect, form a suspension within the primary liquid. In this way, the drink can be textured. The device may be provided with two or more nozzles for providing respectively the suspension of bubbles forming the textured liquid and the head of bubbles on the surface of the liquid. It is also possible to arrange for a single nozzle to achieve both the texturing and the head at different respective stages of producing the bubbles, for instance as the pressure of the foaming gas within the device decreases. It is also possible to include a fine mesh or grate over the one or more nozzles to create further break up of the bubbles and increased sheer whilst utilising a larger nozzle diameter that may further support ease of fabrication.

1-32. (canceled)

33. A method of providing a foamed secondary liquid in a drink, the method including:
providing the secondary liquid with a foaming gas under pressure;
releasing the secondary liquid and foaming gas into a primary liquid such that the drink is formed and bubbles of secondary liquid are formed in the primary liquid.

34. A method according to claim 33 wherein proteins/constituents within one or both of the primary liquid and the secondary liquid denature.

35. A method according to claim 33 wherein the secondary liquid is provided under pressure and contains the foaming gas dissolved therein and wherein, upon releasing the secondary liquid into the primary liquid, the foaming gas comes out of solution.

36. A method according to claim 33 further including:
heating the primary liquid; wherein the secondary liquid is released into the hot primary liquid such that protein/constituents in the secondary liquid denature.

37. A method according to claim 33 wherein the secondary liquid is released into the primary liquid through a nozzle configured to cause sheer of the secondary liquid thereby to denature proteins in the secondary liquid.

38. A method according to claim 33 including providing a milk product as one of the two liquids and preferably as the secondary liquid.

39. A method according to claim 33 wherein the secondary liquid is released into the primary liquid such that the bubbles of secondary liquid formed in the primary liquid form a suspension so as to texture the drink.

40. A foaming device for providing a drink from a primary liquid, the device including:
a housing defining an internal volume for housing a secondary liquid and a source of foaming gas and defining a nozzle communicating between the internal volume and an exterior of the housing; and
a plug for sealing the nozzle so as to prevent communication between the internal volume and the exterior of the housing, the plug being selectively openable to allow communication between the internal volume and the exterior of the housing.

41. A foaming device according to claim 40 wherein the internal volume is configured to house foaming gas under pressure.

42. A foaming device according to claim 41 housing a foaming gas under pressure.

43. A foaming device according to claim 40 wherein the housing is configured to house under pressure the secondary liquid containing the foaming gas dissolved therein.

44. A foaming device according to claim 43 housing under pressure a secondary liquid containing dissolved foaming gas.

45. A foaming device according to claim 40 wherein the internal volume includes a first volume for housing the foaming gas and a second volume for housing the secondary liquid.

46. A foaming device according to claim 40 wherein the source of foaming gas is at least one compound able to produce the foaming gas by reaction.

47. A foaming device according to claim 46 wherein the housing defines at least one chamber respectively for said at least one compound and a rupturable divide between said at least one chamber and said internal volume.

48. A foaming device according to claim 47 wherein the rupturable divide is configured to rupture so as to release foaming gas into the secondary liquid.

49. A foaming device according to claim 47 wherein the rupturable divide is configured to be ruptured so as to allow secondary liquid to mix with the at least one compound thereby to produce the foaming gas in the secondary liquid.

50. A foaming device according to claim 40 wherein the housing defines a supplementary internal volume for housing a tertiary component for release into the primary liquid.

51. A foaming device according to claim 50 wherein the supplementary internal volume provides a communicable path between the nozzle and the internal volume, is separated from the internal volume by a rupturable seal and is configured to house a tertiary powder such that, upon opening the plug and rupture of the seal, secondary liquid from the internal volume flows through the supplementary internal volume and carries tertiary powder out of the nozzle.

52. A foaming device according to claim 51 housing a tertiary powder in the supplementary internal volume, the tertiary powder being at least partly soluble by the secondary liquid flowing through the supplementary internal volume.

53. A foaming device according to claim 51 housing a tertiary powder in the supplementary internal volume, the tertiary powder being at least partly insoluble in the primary liquid and suitable for forming a suspension within the primary liquid.

54. A foaming device according to claim 51 housing a tertiary powder in the supplementary internal volume, the tertiary powder being suitable for forming nucleation sites upon which the bubbles may form.

55. A foaming device according to claim 50 wherein the supplementary internal volume is configured to house a tertiary liquid for release into the primary liquid with or after the secondary liquid.

56. A foaming device according to claim 55 housing a tertiary liquid in the supplementary internal volume.

57. A foaming device according to claim 55 wherein the housing further defines a supplementary nozzle communicating between the supplementary internal volume and the exterior of the housing and a supplementary plug for sealing the supplementary nozzle so as to prevent communication between the supplementary internal volume and the exterior of the housing, the supplementary plug being selectively openable to allow communication between the supplementary internal volume and the exterior of the housing.

58. A foaming device according to claim 57 wherein the supplementary plug is integral with the plug.

59. A foaming device according to claim 40 wherein the plug is at least partly constructed from a material which, at temperatures above a predetermined temperature, opens the nozzle and thus releases secondary liquid and foaming gas from the housing.

60. A foaming device according to claim 40 wherein the plug is at least partly constructed from a material which, at temperatures above a predetermined temperature, opens the nozzles as a result of increased pressure within the internal volume and thus releases secondary liquid and foaming gas from the housing.

61. A foaming device according to claim 40 wherein the nozzle is configured to cause sheer of the secondary liquid thereby to denature proteins in the secondary liquid.

62. A foaming device according to claim 40 wherein the nozzle is configured to produce bubbles in suspension in the primary liquid so as to texture the drink.

63. A foaming device according to claim 40 housing a liquid milk product as the secondary liquid.

64. A disposable drinks cup having a foaming device according to claim 40 located at or above the bottom internal surface of the cup in a manner such that when the secondary liquid is released it has to travel through the at least part of the primary liquid to reach the surface of the primary liquid.
